(19) United States
(12) Patent Application Publication
(10) Pub. No.: US 2019/0224875 A1
(43) Pub. Date: Jul. 25, 2019

(54) Safety Knife Device

(71) Applicant: Eliezer D. Rodal, Phoenix, AZ (US)

(72) Inventor: Eliezer D. Rodal, Phoenix, AZ (US)

(21) Appl. No.: 15/880,015

(22) Filed: Jan. 25, 2018

(51) Int. Cl. B26B 27/00; B26B 5/00

(52) U.S. Cl. CPC B26B 27/007; B26B 5/00

(57) ABSTRACT

A safety knife device includes a knife blade having a working end portion and a securing portion opposite the working end portion; and a knife handle having, a handle first end coupled to the securing portion of the knife blade, and a handle second end to receive a finger protecting article. The handle second end comprises a seating portion that is tapered to geometrically provide for the seating portion of the handle second end to nest at least partially within an opening of the finger protecting article such that an external surface of the finger protecting article lies substantially co-planar to the un-tapered, non-nested portion of the handle second end when received by the seating portion of the handle second end. The knife handle and the finger protecting article may also include integrated magnets of opposite polarity or a detent mechanism to facilitate coupling and securing the finger protecting article to the handle second end.

### BACKGROUND OF THE DEVICE

Knives as a tool have been used by man for eons for countless applications, and many specialty knives have been developed for various specialty purposes, particularly for cooking and food preparation. For example, butcher knives, filleting knives, boning knives, bread knives, paring knives, and a host of others have been developed to aid the food preparer. While seasoned and/or professional cooks and chefs generally understand how to operate knives with fluency and skill, the layperson in their kitchen may operate a knife not as efficiently, and routinely may injure themselves by using a knife in an unsafe and/or an uneducated manner. For example, a layperson user who may use a paring knife to regularly peel vegetables will hold the item to be peeled in one hand and then peel the item with the knife in their other hand. In a typical fashion, the user positions the knife at a distal position of the item to be peeled with the blade towards the user, and then pulls the knife towards their thumb, thus completing the peeling action. If the user is not proficient with the knife or careless with its operation the user may “cut” their thumb or other fingers when completing the peeling action.

In another manner, a user may operate the knife not in a peeling action, but rather in a chopping action, wherein the user places the item to be “chopped” on a surface and holds the item in place with one hand by the fingers, which a proficient user knows to curl underneath; and uses the other hand to operate the knife. The proficient user knows to slightly curl their fingers underneath and “ride” the blade back along the item using their distal knuckle as a guide as they move their item holding hand back during the chopping motion. A novice, careless or uneducated user may not understand how to chop in the proper manner and may “cut” themselves; e.g. such as the tips of their fingers.

What is needed and absent from the prior art is a knife device that incorporates a finger protection article for the user to prevent or deter any unintended cutting of the user and/or user's finger when they operate the knife. Moreover, what is needed is a knife device that has the protection article incorporated with the knife for easy storage and retrieval.

### SUMMARY OF THE DEVICE

Among various representative embodiments, a safety knife device comprises a knife blade comprising a working end portion and a securing portion opposite the working end portion, a knife handle, and a finger protecting article. The knife handle comprises a handle first end coupled to the securing portion of the knife blade, and a handle second end to receive the finger protecting article. The safety knife device comprises the handle second end to comprise a seating potion comprising a taper or recess to geometrically provide for the seating portion of the handle second end to nest at least partially within an opening of the finger protecting article such that an external surface of the finger protecting article lies substantially co-planar to the un-tapered or un-recessed, non-nested portion of the handle second end when the finger protecting article is received by the handle second end.

Among various embodiments, the safety knife device further comprises the knife handle and the finger protecting article to comprise at least one of; integrated magnets of opposite polarity and a detent mechanism to facilitate securing the finger protecting article to the handle second end.

Among various embodiments, the safety knife device may comprise some, all, or none of the following: (a) a plurality of grouped protrusions at a finger protecting article, external, distal end to facilitate securing a product to a cutting surface for cutting by the knife blade when the finger protecting article is worn by a user; (b) a portion of the finger protecting article comprises a textured external surface to facilitate grasping and removing the finger protecting article from the handle second end; (c) a finger protecting article comprises an internal textured surface to deter the finger protecting article from becoming removed from the user's finger upon which the finger protecting article is seated during use; (d) a finger protecting article comprises an integrated plate positioned at least upon a portion of an external surface of the finger protecting article to deter cutting the finger protecting article by the knife blade during use; (e) a finger protecting article comprises at least one of; a flexible silicon based material, a vulcanized rubber material, and a rigid synthetic plastic material; and (f) a knife handle comprises a contoured external surface to conform to the user's hand grasping profile.

### BRIEF DESCRIPTION OF THE DRAWINGS

A more complete understanding of the safety knife may be derived by referring to the detailed description of the device and claims when considered in connection with the following illustrative FIGS. In the following FIGS., like reference numbers refer to similar elements and steps throughout the FIGS.

FIG. 1 representatively illustrates an exploded view of an embodiment of a safety knife device;

FIG. 2 representatively illustrates a perspective view of the safety knife device; and

FIG. 3 representatively illustrates a close-up view of the safety knife device's handle second end, handle second end seating portion, and finger protecting article.

Elements in the FIGS. are illustrated for simplicity and clarity and have not necessarily been rendered according to any particular configuration. For example, elements shown may be constructed and/or assembled concurrently or in different order or embodiments, and are illustrated in the FIGS. to help to improve understanding of embodiments of the safety knife device.

### DETAILED DESCRIPTION OF THE DEVICE

The present device may be described herein in terms of various functional components and such functional components may be realized by any number of hardware components configured to perform the specified functions and achieve the various results. For example, the present device may employ various knife blade and handle configurations that incorporates a finger protection article. In addition, the present device may be practiced in conjunction with any number of manners for cutting, paring, filleting, chopping and the like use of a knife; and any described devices are merely exemplary embodiments of the device. Further, the present device may employ any number of unique and/or conventional techniques for protecting the finger of a user during use of the safety knife. Moreover, those skilled in the art will appreciate that the following detailed description, while directed towards a knife, the various features may be incorporated into other utility devices, for example, such as a vegetable peeler.

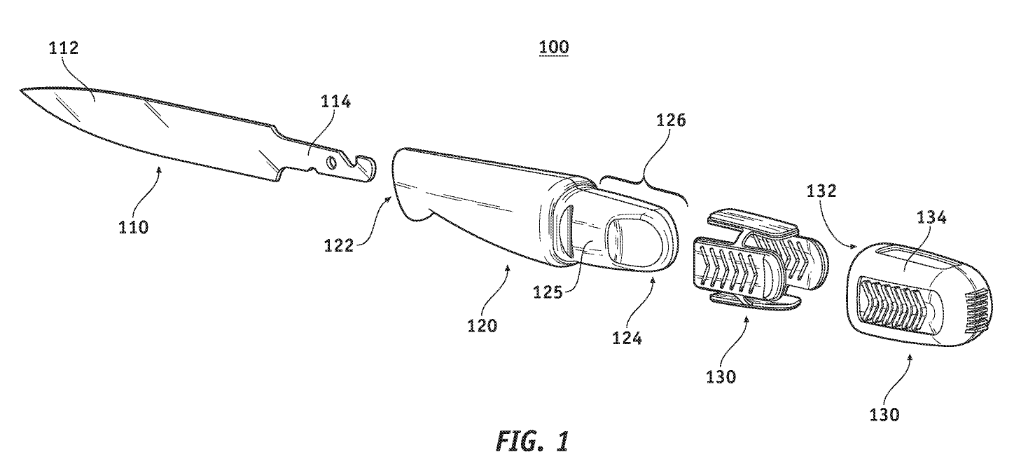

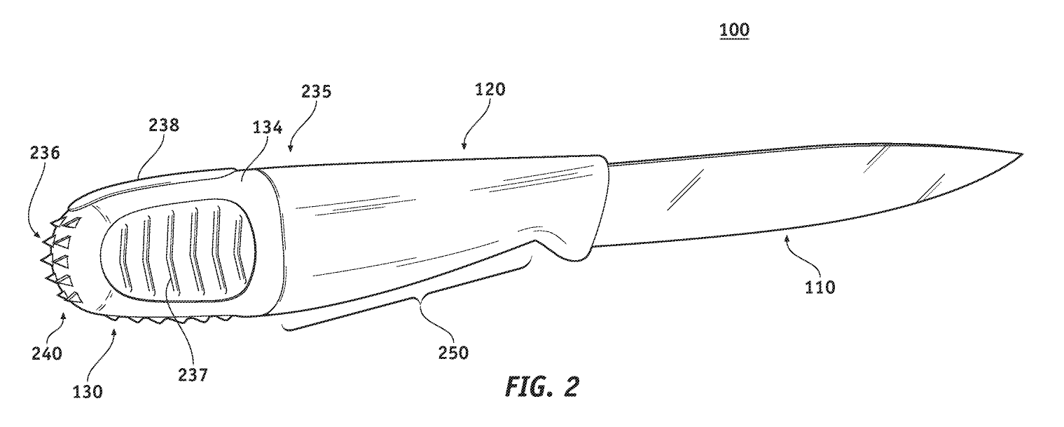

Various embodiments of the present device may be applied to any safety knife. Referring now to FIG. 1, a safety knife device 100 comprises a knife blade 110 comprising a working end portion 112 and a securing portion 114 opposite working end portion 112, and a knife handle 120. Knife handle 120 comprises a handle first end 122 that couples to securing portion 114 of knife blade 110; and a handle second end 124 of which a portion, seating portion 125, is configured to receive a finger protecting article 130 of which two configurations are depicted by FIG. 1. Safety knife device 100 further comprises the seating portion 125 of handle second end 124 to comprise a taper 126 to geometrically provide for seating portion 125 of handle second end 124 to nest at least partially within an opening 132 of finger protecting article 130 such that an external surface 134 of finger protecting article 130 lies substantially co-planar to the un-tapered, non-nested portion 235 (FIG. 2) of handle second end 124 when received by handle second end 124, and can be best seen by momentary reference to FIG. 2.

Among various embodiments and with reference to FIG. 2, safety knife device 100 may comprise some, all, or none of the following, a plurality of grouped protrusions 236 at a finger protecting article, external, distal end 240 to facilitate securing a product to a cutting surface for cutting by knife blade 110 when finger protecting article 130 is worn by a user. Safety knife device 100 may also comprise a portion of finger protecting article 130 to comprise a textured external surface 237 to facilitate grasping and removing finger protecting article 130 from handle second end 124. Although not shown, finger protecting article 130 may also comprise an internal textured surface to deter finger protecting article 130 from becoming removed from a user's finger upon which finger protecting article 130 is seated during use. Among embodiments, finger protecting article 130 may also comprise an integrated plate 238 affixed to or positioned within at least a portion of external surface 134 of finger protecting article 130 to deter cutting finger protecting article 130 by knife blade 110 during use. Moreover, safety knife device 100 may comprise finger protecting article 130 to comprise at least one of; a flexible silicon based material, a vulcanized rubber material, and a rigid synthetic plastic material; and knife handle 120 may comprise a contoured external surface 250 to conform to a user's hand grasping profile.

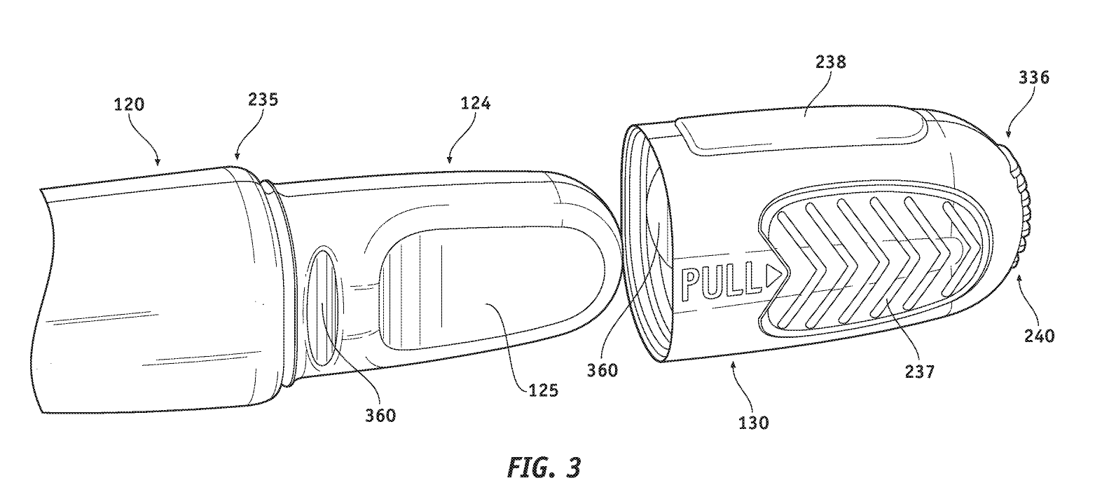

Among various embodiments, safety knife device 100 may further comprise knife handle 120 and finger protecting article 130 to comprise at least one of; integrated magnets of opposite polarity (not shown) and a detent mechanism 360 (FIG. 3.) to facilitate securing finger protecting article 130 to handle second end 124.

As disclosed above, safety knife device 100 comprises knife blade 110. Among various embodiments, knife blade 110, particularly working end portion 112, may comprise various knife blade configurations, such as specifically configured for food preparation, including, butcher knives, filleting knives, boning knives, bread knives, paring knives, and the like. Moreover, knife blade may comprise of various steel, ceramic, aluminum, and alloyed material compositions, whether either one of natural and/or synthetic composition. While the present device disclosed is directed towards a knife for food preparation, those skilled in the art will appreciate that knives for other uses may be likewise configured, such as for woodworking, camping, fishing, hunting, military use, sport, general utility, etc. As shown by the exploded view of FIG. 1, knife blade comprises securing portion 114, which is configured to be coupled to a handle, such as handle 120. Securing portion 114 may be riveted to, encased by, glued to, molded about by and otherwise secured by/to handle 120. In some embodiments, blade 110 may be alternatively hinged to a handle, similar to handle 120, such that blade 110 may fold and be secured within handle 120, the manner generally known by those skilled in the art with respect to a folding “pocket knife” configuration. Safety knife device 100 may further comprise a protective sheath (not shown) to protect blade 110, as well as the user of safety knife device 100.

As disclosed above, safety knife device 100 comprises handle 120 comprising handle first end 122 and handle second end 124. Handle 120 may comprise any of a variety of configurations and profiles generally known to those skilled in the art with respect to known knife handle configurations. For example, handle 120 may be contoured to accommodate a user's hand grasping profile, smooth surfaced, textured to aid gripping the handle, indented at portions to accommodate various finger positions upon the handle, etc. Moreover, handle 120, may comprise material configurations, such as a wooden material, metallic, synthetic plastic, vulcanized rubber, silicon material, ceramic based material, and the like, whether natural and/or synthetic in nature. Moreover, handle 120 may secure to knife blade 110 as described previously, and handle 120 may be simple in nature, decoratively carved, etched, printed, embossed, and the like.

Among various embodiments and best seen by FIGS. 1 and 3, handle 120 comprises seating portion 125 at handle second end 124. Seating portion 125 is configured to receive and, among some embodiments, secure finger protecting article 130 to seating portion 125. As can be seen by the FIGS., seating portion 125 is tapered, taper 126, to receive finger protecting article 130, but other configurations may comprise step-down configurations, recesses, sleeves, and the like. Moreover, taper 126 is configured to receive finger protecting article 130 such that external surface 134 of finger protecting article 130, when received by (nested to) seating portion 125 provides for a smooth, substantially coplanar transition between external surface 134 and the un-tapered, non-nested portion 235 (FIG. 2) of handle second end 124. By this configuration, safety knife device 100 depicts a desirable, unified handled knife configuration, save the elements described herein with respect to the finger protecting article.

As disclosed earlier, safety knife 100 may comprise a plurality of grouped protrusions 236 at a finger protecting article, external, distal end 240 to facilitate securing a product to a cutting surface for cutting by knife blade 110. As depicted by FIG. 2, protrusions 240 may comprise a grouping of “pointed” elements such that when finger protecting article 130 is worn by a user, the user may push onto the product being cut to aide in preventing the product from moving about during use of the safety knife. However, those skilled in the art will appreciate that embodiments of safety device 100 may comprise other types and configurations of protrusions 240, such as those depicted by elements 336 of FIG. 3; or no protrusions at all.

As disclosed earlier, safety knife device 100 may also comprise a portion of finger protecting article 130 to comprise a textured external surface 237 to facilitate grasping and removing finger protecting article 130 from handle second end 124. As depicted by the various FIGS., safety knife 100 may comprise various configurations, orientations, patterns, and the like of textured surfaces, or may be devoid of any textured surfaces.

As disclosed earlier, finger protecting article 130 may also comprise an integrated (or affixed) plate 238 positioned within at least a portion of external surface 134 of finger protecting article 130 to deter cutting finger protecting article 130 by knife blade 110 during use. As can be best seen by FIGS. 2 and 3, integrated plate 238 comprises a plate like configuration, but other configurations are contemplated by this disclosure. Moreover, integrated plate comprises a metallic material, but other materials, bet they natural and/or synthetic, may be employed. And among some embodiments, safety knife 100 may be devoid of such integrated plate 238.

As disclosed earlier, safety knife device 100 may further comprise knife handle 120 and finger protecting article 130 to comprise at least one of; integrated magnets of opposite polarity (not shown) and a detent mechanism 360 (FIG. 3.) to facilitate securing finger protecting article 130 to handle second end 124. However, other securing mechanisms other than magnets and/or a detent mechanism may be employed, such as friction fit tabs, springs, pins, locks, and other like elements generally known to secure one physical element to another. In an embodiment, finger protecting article 130 may screw to handle second end 124.

In the foregoing specification, the safety knife device has been described with reference to specific embodiments. Various modifications and changes may be made, however, without departing from the scope of the present device as set forth in the claims. The specification and FIGS. are illustrative, rather than restrictive, and modifications are intended to be included within the scope of the present device. Accordingly, the scope of the device should be determined by the claims and their legal equivalents rather than by merely the specific embodiments described.

For example, the components and/or elements recited in any physical embodiment claims may be assembled or otherwise operationally configured in a variety of permutations and are accordingly not limited to any specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes”, “is”, or any variation thereof, are intended to reference a non-exclusive inclusion, such that a process, method, article, device, composition or apparatus that comprises a list of elements does not include only those elements recited, but may also include other elements not expressly listed or inherent to such process, method, article, device, composition or apparatus. Other combinations and/or modifications of the above-described structures, arrangements, applications, proportions, elements, materials or components used in the practice of the present device, in addition to those not specifically recited, may be varied or otherwise particularly adapted to specific environments, manufacturing specifications, design parameters or other operating requirements without departing from the general principles of the same.

1. A safety knife device comprises:
a knife blade comprising a working end portion and a securing portion opposite the working end portion;
a knife handle; and
a finger protection article,
wherein,
the knife handle comprises a handle first end coupled to the securing portion of the knife blade, and
a handle second end to receive the finger protecting article, wherein the handle second end further comprises a seating portion comprising a taper to geometrically provide for the handle second end to nest at least partially within an opening of the finger protecting article such that an external surface of the finger protecting article lies substantially co-planar to the un-tapered, non-nested portion of the handle second end when received by the seating portion of the handle second end.

2. The safety knife of claim 1, wherein the finger protecting article comprises a plurality of grouped protrusions at a finger protecting article, external, distal end to facilitate securing a product to a cutting surface for cutting by the knife blade.

3. The safety knife of claim 2, wherein the handle second end and the finger protecting article comprise integrated magnets of opposite polarity to facilitate coupling and securing the finger protecting article to the handle second end.

4. The safety knife of claim 3, wherein at least a portion of the finger protecting article comprises a textured external surface to facilitate grasping and removing the finger protecting article from the handle second end.

5. The safety knife of claim 4, wherein the seating portion of the handle second end and the finger protecting article comprise a detent mechanism to facilitate securing the finger protecting article to the seating portion of the handle second end.

6. The safety knife of claim 5, wherein the finger protecting article comprises an internal textured surface to deter the finger protecting article from becoming removed from a user's finger upon which the finger protecting article is seated during use.

7. The safety knife of claim 6, wherein the finger protecting article comprises an integrated plate positioned at least upon a portion of an external surface of the finger protecting article to deter cutting the finger protecting article by the knife blade during use.

8. The safety knife of claim 7, wherein the finger protecting article comprises at least one of; a flexible silicon based material, a vulcanized rubber material, and a rigid synthetic plastic material.

9. The safety knife of claim 8, wherein the knife handle comprises a contoured external surface to conform to a user's hand grasping profile.

10. A safety knife device comprises:
a knife blade; and
a knife handle, wherein the knife handle comprises a handle first end to secure the knife blade, and a handle second end removable from the knife handle and configured to operate as a finger protecting article,
wherein the finger protecting article is ergonomically configured to fit upon a finger of a user to protect the user's finger from cutting by the knife blade during use.

11. The safety knife of claim 10, wherein the finger protecting article comprises a plurality of grouped protrusions at a finger protecting article, external, distal end to facilitate securing a product to a cutting surface for cutting by the knife blade.

12. The safety knife of claim 11, wherein the knife handle and the finger protecting article comprise at least one of; integrated magnets of opposite polarity and a detent mechanism to facilitate securing the finger protecting article to the handle second end.

13. The safety knife of claim 12, wherein at least a portion of the finger protecting article comprises a textured external surface to facilitate grasping and removing the finger protecting article from the knife handle.

14. The safety knife of claim 13, wherein the finger protecting article comprises an internal textured surface to deter the finger protecting article from becoming removed from the user's finger upon which the finger protecting article is seated during use.

15. The safety knife of claim 14, wherein the finger protecting article comprises an integrated plate positioned at least upon a portion of an external surface of the finger protecting article to deter cutting the finger protecting article by the knife blade during use.

16. The safety knife of claim 15, wherein the finger protecting article comprises at least one of; a flexible silicon based material, a vulcanized rubber material, and a rigid synthetic plastic material.

17. The safety knife of claim 16, wherein the knife handle comprises a contoured external surface to conform to a user's hand grasping profile.

18. A method for manufacturing a safety knife device comprises:
forming a knife blade comprising a working end portion and a securing portion opposite the working end portion; and
providing a knife handle comprising,
forming a handle first end and coupling the handle first end to the securing portion of the knife blade, and
forming a handle second end to receive a formed finger protecting article, wherein the handle second end comprises a seating portion comprising a taper to geometrically provide for the seating portion of the handle second end to nest at least partially within an opening of the finger protecting article such that an external surface of the finger protecting article lies substantially co-planar to the un-tapered, non-nested portion of the handle second end when received by the seating portion of the handle second end.

19. The method of claim 18, wherein the formed handle second end and the formed finger protecting article comprise at least one of; integrated magnets of opposite polarity and a detent mechanism to facilitate securing the finger protecting article to the handle second end.

20. The safety knife of claim 19, wherein the formed finger protecting article comprises at least one of; a flexible silicon based material, a vulcanized rubber material, and a rigid synthetic plastic material.
